(19) United States
(12) Patent Application Publication
(10) Pub. No.: US 2011/0095221 A1
(43) Pub. Date: Apr. 28, 2011

(54) EXHAUST BRAKE VALVE ASSEMBLY

(76) Inventor: Gabriel GAVRIL, Coquitlam (CA)

(21) Appl. No.: 12/912,206

(22) Filed: Oct. 26, 2010

Related U.S. Application Data
(60) Provisional application No. 61/254,912, filed on Oct. 26, 2009.

(51) Int. Cl. F16K 1/22

(52) U.S. Cl. 251/306

(57) ABSTRACT

An exhaust gas flow control valve assembly comprises a valve casing forming an exhaust gas passage defining a cylindrical inner peripheral surface and a butterfly-type exhaust gas flow control valve disposed within the exhaust gas passage and movable between an open position and a closed position. The flow control valve includes a single-piece valve disc member having a circumferential groove formed in an outer peripheral surface thereof, and a flat, resilient stainless steel sealing ring disposed in the groove with a clearance for radial displacement of the sealing ring relative to the groove. The sealing ring includes a cylindrical outer peripheral surface provided with rounded corners. The outer peripheral surface of the sealing ring is in firm contact with the inner peripheral surface of the valve casing solely by an elastic force of the sealing ring when the exhaust gas flow control valve is in the closed position.

### CROSS-REFERENCE TO RELATED APPLICATION

This application claims the benefit under 35 U.S.C. 119(e) of U.S. Provisional Patent Application Ser. No. 61/254,912 filed Oct. 26, 2009 by Gavril, G., which is hereby incorporated herein by reference in its entirety and to which priority is claimed.

### BACKGROUND OF THE INVENTION

1. Field of the Invention

The present invention relates to valve assemblies in general and, more particularly, to a butterfly-type valve of an exhaust gas flow control valve assembly.

2. Description of the Prior Art

For internal combustion engines (IC engine), especially diesel engines of large trucks, engine braking is an important feature for enhanced vehicle safety. Consequently, the diesel engines in vehicles, particularly large trucks, are commonly equipped with exhaust brake systems. Exhaust brake systems are typically used on engines where compression release loading is too great for the valve train. The exhaust brake mechanism includes an exhaust brake valve assembly comprising a restrictor element mounted in the exhaust system. When the restrictor element is closed, backpressure resists the exit of gases during the exhaust cycle and provides a braking function. The exhaust brake system provides less braking power than a compression release engine brake, but also at less cost. The retarding power of an exhaust brake falls off sharply as engine speed decreases. This happens because the restriction is optimized to generate maximum allowable backpressure at rated engine speed. The restriction is simply insufficient to be effective at the lower engine speeds.

The conventional exhaust brake valves are often provided with a face seal in order to reduce gas leakage therethrough. However, the face seals do not provide satisfactory sealing in the aggressive, high-temperature environment of the exhaust brake valves.

Thus, the exhaust brake systems of the prior art are susceptible to improvements that may enhance their performance.

### SUMMARY OF THE INVENTION

The present invention provides an improved exhaust gas flow control valve assembly, especially suitable for an exhaust brake system of an internal combustion engine to be arranged in an exhaust passage of the internal combustion engine. The exhaust gas flow control valve assembly comprises a valve casing forming an exhaust gas passage defining a cylindrical inner peripheral surface of the valve casing, and a butterfly-type exhaust gas flow control valve disposed within the cylindrical exhaust gas passage and movable between an open position and a closed position blocking fluid communication through the cylindrical exhaust gas passage to control the exhaust gas flow through the exhaust gas passage of the valve casing. The exhaust gas flow control valve includes a single-piece valve disc member having a circumferential groove formed in a circumferentially outer peripheral surface thereof, and a flat, substantially annular resilient stainless steel sealing ring disposed in the annular groove with a clearance for radial displacement of the sealing ring relative to the annular groove. In turn, the sealing ring includes a cylindrical outer peripheral surface provided with rounded corners. According to the present invention, the cylindrical outer peripheral surface of the sealing ring is in firm contact with the cylindrical inner peripheral surface of the valve casing solely by an elastic force of the sealing ring when the exhaust gas flow control valve is in the closed position thereof.

The exhaust brake valve assembly of the present invention provides low or no leakage sealing between the inner peripheral surface of the valve casing and the sealing ring of the exhaust brake valve, can handle high backpressure of the exhaust gases, and resists seizing if not used regularly. Unlike the conventional exhaust brake valves, the brake valve assembly of the present invention is especially efficient at low engine speeds and provides substantial braking power at low engine speeds.

### BRIEF DESCRIPTION OF THE DRAWINGS

Other objects and advantages of the invention will become apparent from a study of the following specification when viewed in light of the accompanying drawings, wherein:

FIG. 1A is a perspective view of an exhaust brake valve assembly according to a preferred embodiment of the present invention;

FIG. 1B is a side view of the exhaust brake valve assembly according to the preferred embodiment of the present invention;

FIG. 1C is a top view of the exhaust brake valve assembly according to the preferred embodiment of the present invention;

FIG. 1D is a front view of the exhaust brake valve assembly according to the preferred embodiment of the present invention;

FIG. 2A is a perspective view of a casing of the exhaust brake valve assembly according to the preferred embodiment of the present invention;

FIG. 2B is a top view of the casing of the exhaust brake valve assembly according to the preferred embodiment of the present invention;

FIG. 2C is a cross-sectional view of the casing of the exhaust brake valve assembly according to the preferred embodiment of the present invention taken along the lines 2C-2C in FIG. 2B;

FIG. 2D is a side view of the casing of the exhaust brake valve assembly according to the preferred embodiment of the present invention;

FIG. 3A is a perspective view of a valve disc member of an exhaust brake valve according to the preferred embodiment of the present invention;

FIG. 3B is a front view of the valve disc member of the exhaust brake valve according to the preferred embodiment of the present invention;

FIG. 3C is a cross-sectional view of the valve disc member of the exhaust brake valve according to the preferred embodiment of the present invention taken along the lines A-A in FIG. 3B;

FIG. 3D is an enlarged, partial cross-sectional view of the valve disc member of the exhaust brake valve according to the preferred embodiment of the present invention shown in the circle D in FIG. 3C;

FIG. 4A is a perspective view of a sealing ring of the exhaust brake valve according to the preferred embodiment of the present invention in an installed state;

FIG. 4B is a front view of the sealing ring according to the preferred embodiment of the present invention in the installed state;

FIG. 4C is a cross-sectional view of the sealing ring according to the preferred embodiment of the present invention taken along the lines A-A in FIG. 4B;

FIG. 4D is an enlarged, partial cross-sectional view of the sealing ring of the exhaust brake valve according to the preferred embodiment of the present invention shown in the circle B in FIG. 4C;

FIG. 5A is a perspective view of the sealing ring of the exhaust brake valve according to the preferred embodiment of the present invention in a free state;

FIG. 5B is a front view of the sealing ring according to the preferred embodiment of the present invention in the free state;

FIG. 6A is a cross-sectional view of the exhaust brake valve according to the preferred embodiment of the present invention; and

FIG. 6B is an enlarged, partial cross-sectional view of the exhaust brake valve according to the preferred embodiment of the present invention shown in the circle B in FIG. 6A.

### DESCRIPTION OF PREFERRED EMBODIMENTS

The preferred embodiment of the present invention will now be described with the reference to accompanying drawings.

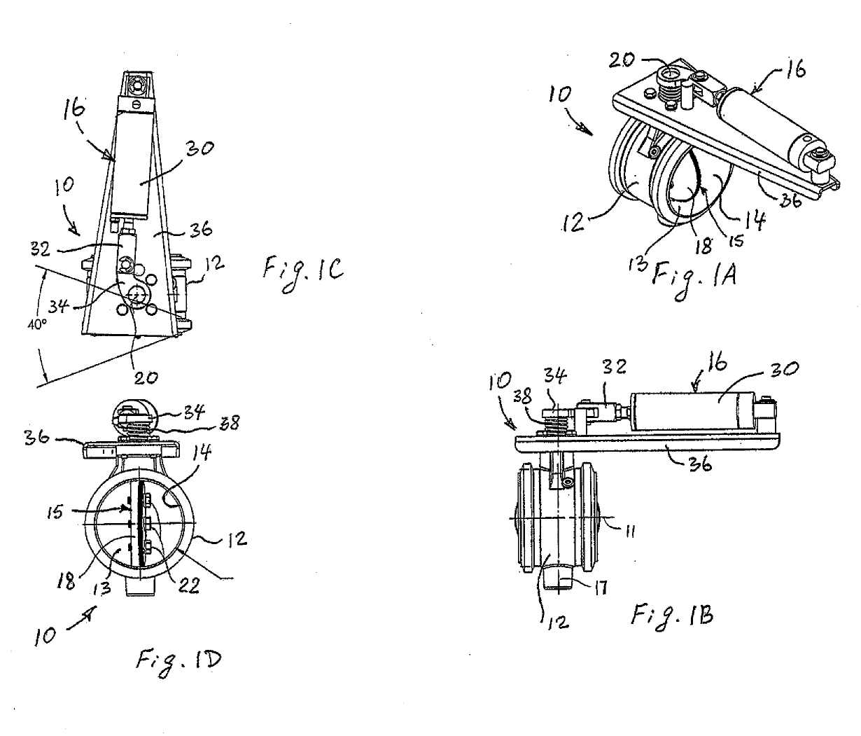

FIGS. 1A-1D schematically depict an exhaust gas flow control valve assembly in the form of an exhaust brake valve assembly (generally denoted by reference numeral 10) according to the preferred embodiment of the present invention provided especially for an exhaust brake system of an internal combustion engine (ICE). The exhaust brake valve assembly 10 is arranged in an exhaust passage of the internal combustion engine.

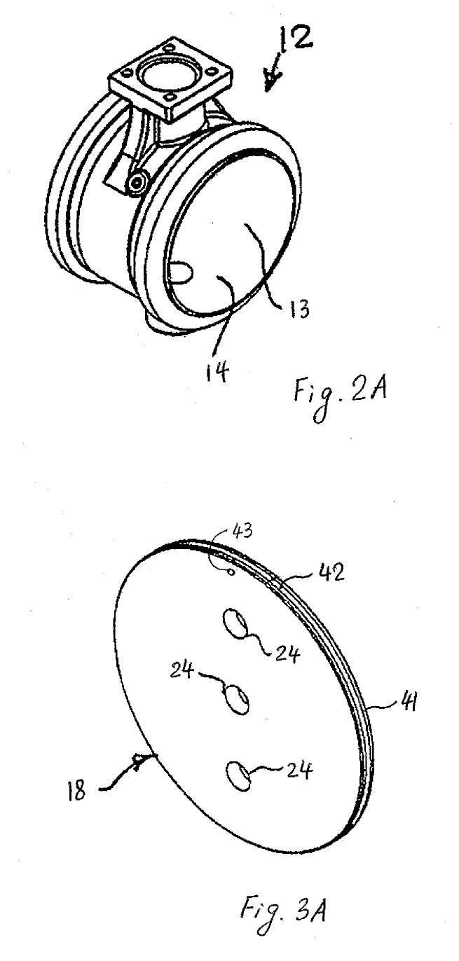

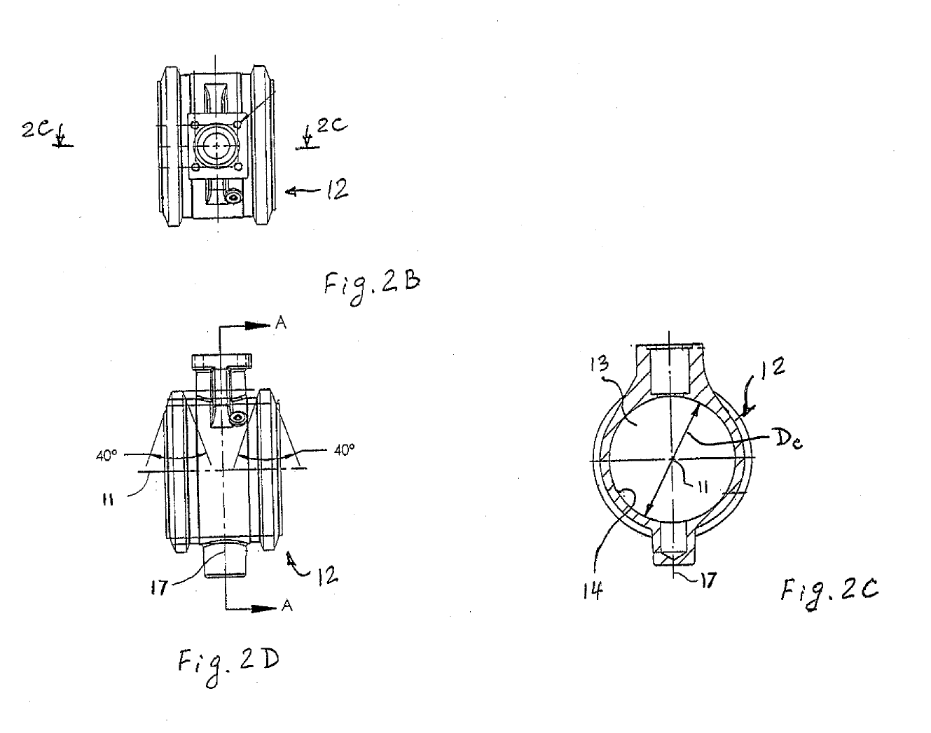

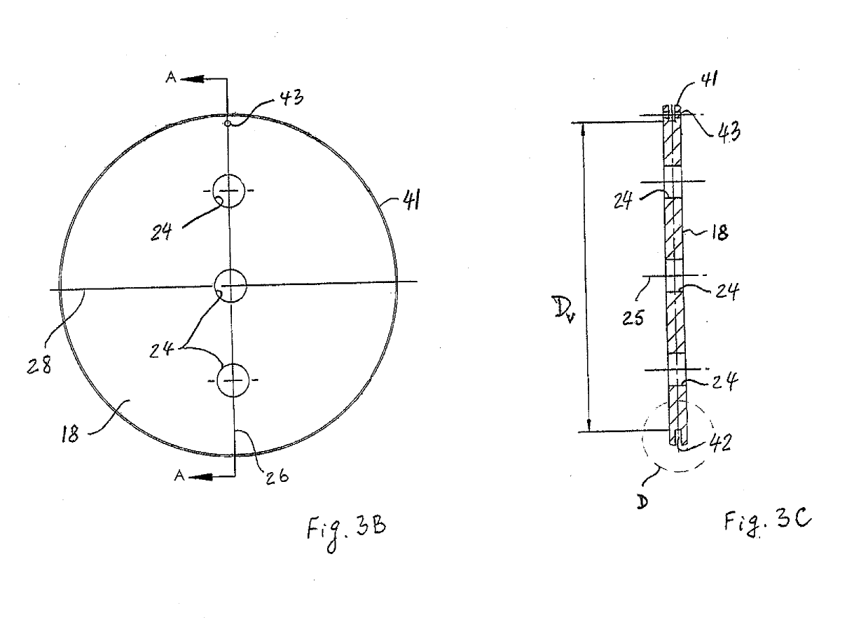

As illustrated in FIGS. 1A-1D, the exhaust brake valve assembly 10 comprises a hollow valve casing 12 made of a metallic material and defining a substantially cylindrical exhaust gas passage 13, a butterfly-type exhaust brake valve (or exhaust gas flow control valve) 15 provided to control the exhaust gas flow through the exhaust gas passage 13 of the valve casing 12, and a valve actuator 16 provided for controlling the exhaust brake valve 15. Preferably, the valve casing 12 is made of a ferrous metal, such as carbon steel. The valve casing 12 has a central axis 11 such that a cylindrical inner peripheral surface 14 defined by the exhaust gas passage 13 of the valve casing 12 is coaxial with the central axis 11 of the valve easing 12. As shown in FIGS. 1D and 2C, the exhaust gas passage 13 has a constant circular cross-section with an interior diameter D_{C} along an entire length thereof.

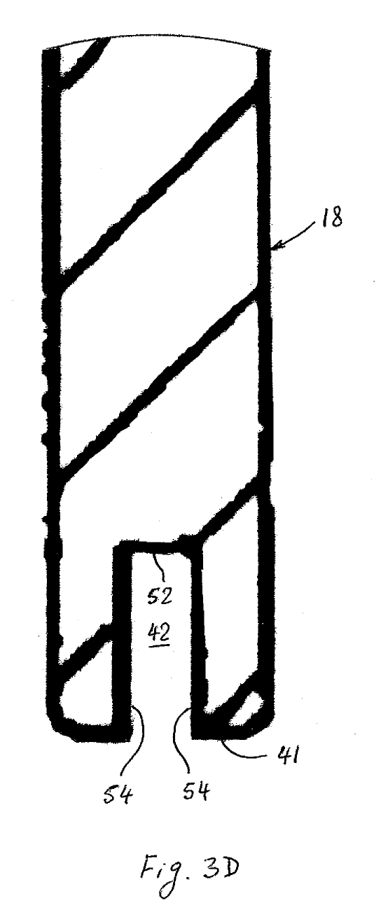

The exhaust brake valve 15 includes a flat, single-piece valve disc member 18 non-movably fastened to a drive shaft 20 with fasteners 22 (such as threaded fasteners). In turn, the drive shaft 20 is mounted to the valve casing 12 for rotation about a rotational axis 17 so as to extend through the exhaust gas passage 13. The valve disc member 18 includes a plurality (preferably three) of fastening holes 24 provided to receive the fasteners 22. The three fastening holes 24 allow for centering of the valve disc member 18 during assembly. Moreover, as illustrated in FIG. 3B, the mounting holes 24 are disposed along a first center axis 26 of the valve disc member 18, while one of the mounting holes 24 is disposed at the intersection of the first center axis 26 and a second center axis 28 of the valve disc member 18 perpendicular to the first center axis 26 thereof. As further illustrated in FIG. 3C, the valve disc member 18 has a third center axis 25 orthogonal to both first and second center axes 26 and 28, respectively. The single-piece valve disc member 18 includes an annular groove 42 integrally formed in a circumferential outer peripheral surface 41 of the valve disc member 18, as shown in FIGS. 3A and 3C. As illustrated in detail in FIG. 3D, the annular groove 42 is formed by a substantially cylindrical bottom surface 52 and a pair of flat, annular opposite side surfaces 54.

The butterfly-type exhaust brake valve 15 is controlled by the valve actuator 16 by selectively rotating the exhaust brake valve 15 about the rotational axis 17 between an open position (shown in FIGS. 1A-1D) and a closed position thereof blocking the fluid communication through the cylindrical exhaust gas passage 13 to control the exhaust gas flow through the exhaust gas passage 13 of the valve casing 12. Referring back to FIGS. 1A-1D, the valve actuator 16 includes a fluid actuator cylinder 30, an actuator rod 32 extending from the fluid actuator cylinder 30 and slideably reciprocating therewithin, and a lever arm 34 rotatably coupled to a distal end of the actuator rod 32 and non-rotatably attached to the drive shaft 20 of the exhaust brake valve 15. The fluid actuator cylinder 30 is mounted to a support plate 36 fixed to the valve casing 12. The valve actuator 16 further includes a coil spring 38 biasing the exhaust brake valve 15 towards the open position thereof. In other words, the exhaust brake valve 15 is movable between the open position and the closed position thereof about the rotational axis 17 due to rotation of the drive shaft 20 relative to the valve casing 12 by the valve actuator 16. The valve actuator 16 used in the preferred embodiment may by a pneumatic actuator or hydraulic actuator.

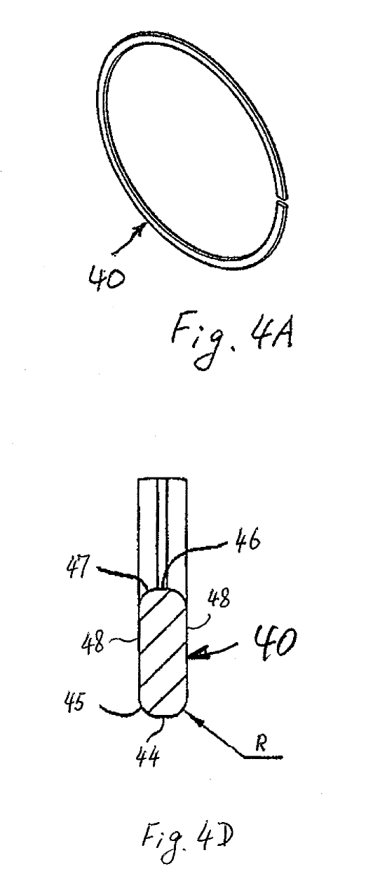

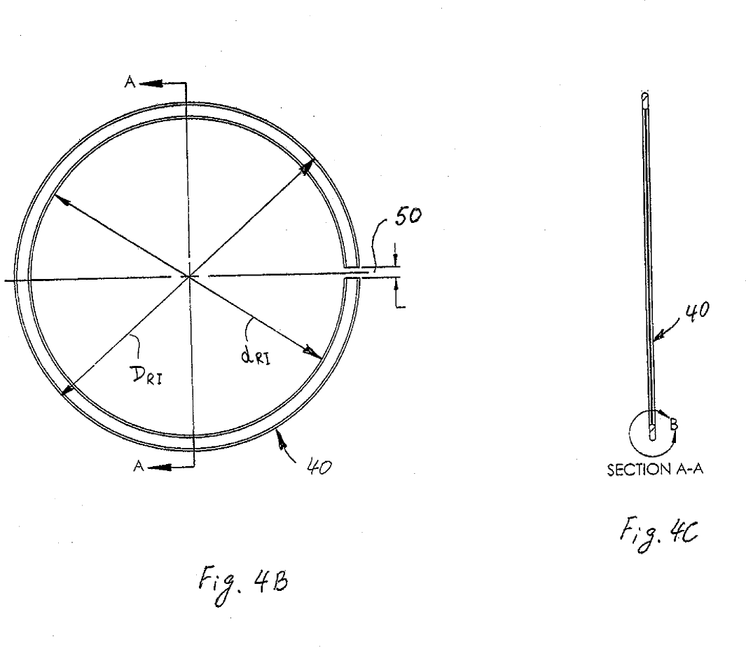

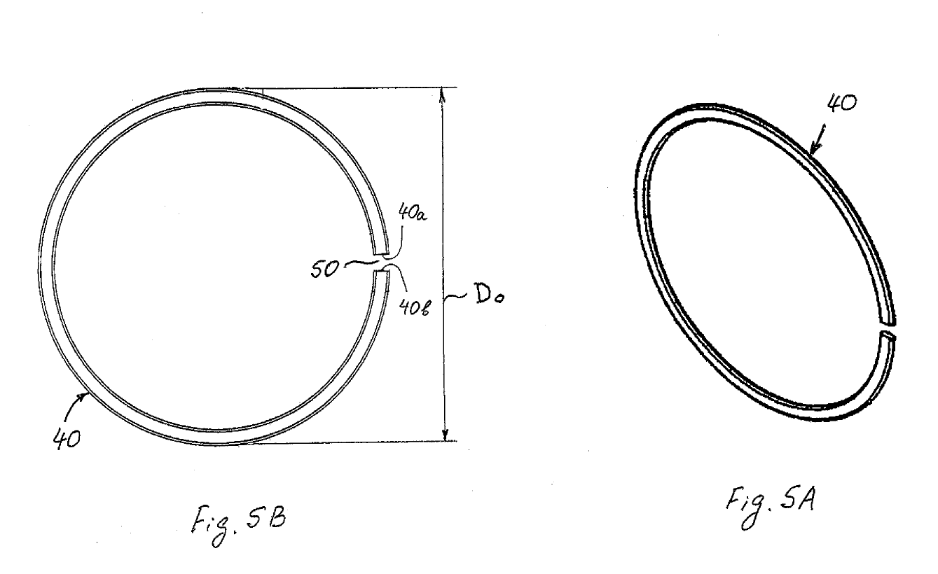

As further illustrated in the accompanying drawings, in order to provide a substantially zero-leakage sealing of the exhaust brake valve 15 within the exhaust gas passage 13 of the valve casing 12 in the closed position of the exhaust brake valve 15, the valve disc member 18 of the exhaust brake valve 15 is provided with a flat, substantially annular, resilient sealing ring in the form of a substantially annular C-ring 40 (shown in FIGS. 4A-5C) provided to fit and be installed in the annular groove 42 of the valve disc member 18. In other word, the valve disc member 18 is grooved to a depth sufficient to accept the sealing ring 40.

The sealing C-ring 40 is made of resilient stainless steel, which is heat treated to 46-54 HRC, while a cylindrical inner peripheral surface 14 of the valve casing 12 is nitrocarburized so as to allow the exhaust brake valve assembly 10 to withstand high temperatures of the exhaust gasses and to improve lubrication, scuffing resistance, fatigue properties, and corrosion resistance. Optionally, the sealing ring 40 is also nitrocarburized. As illustrated in detail in FIG. 4D, the sealing ring 40 has substantially cylindrical outer and inner peripheral surfaces 44 and 46, respectively, and a pair of flat, annular opposite side surfaces 48 substantially perpendicular to the outer and inner peripheral surfaces 44 and 46. As further illustrated in FIGS. 4C and 4D, the cylindrical outer and inner peripheral surfaces 44 and 46 of the sealing ring 40 are provided with rounded corners 45 and 47, respectively, each defined by a radius R, which substantially improve performance and sealing properties of the exhaust brake valve 15.

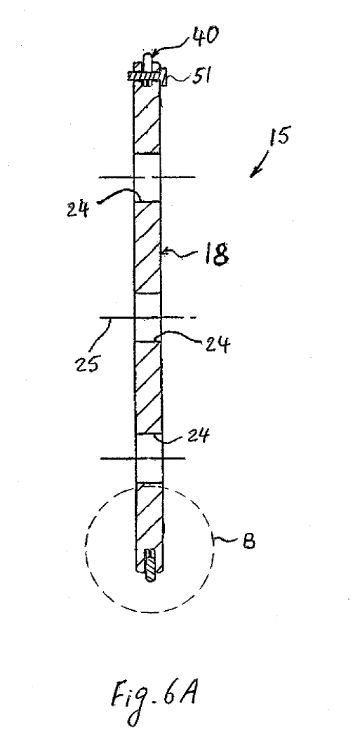

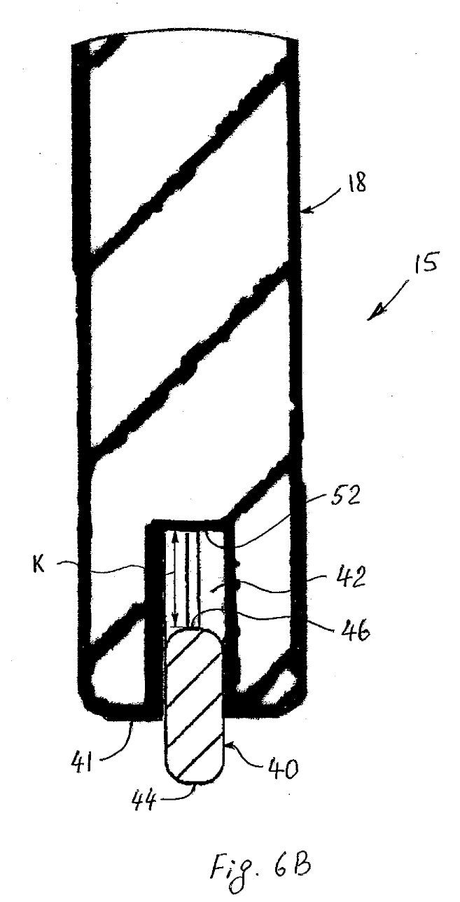

As further illustrated in the accompanying drawings, an outer diameter D₀ of the sealing ring 40 in a free state (shown in FIGS. 5A and 5B) is larger than the interior diameter D_{C} of the exhaust gas passage 13 in the valve casing 12 (shown in FIG. 2C). The sealing ring 40 is substantially oval in the free state thereof, as illustrated in FIGS. 5A-5C. Thus, the sealing ring 40 is mounted into the groove 42 of the valve disc member 18, then compressed and installed within the valve casing 12 with a clearance K between the bottom surface 52 of the circumferential groove 42 of the valve disc member 18 and the cylindrical inner peripheral surface 46 of the sealing ring 40, as illustrated in detail in FIGS. 6A and 6B.

The clearance K between the bottom surface 52 of the circumferential groove 42 and the cylindrical inner peripheral surface 46 of the sealing ring 40 is such that there is enough room within the groove 42 for the stainless steel sealing ring 40 to radially contract and expand into firm contact with the cylindrical inner peripheral surface 14 of the valve casing 12, when the exhaust brake valve 15 is in the closed position thereof, solely by an elastic force of the sealing ring 40 (FIGS. 4A-4C, 6A and 6B show the sealing ring 40 in an installed state). In other words, an inner diameter d_{RI} of the sealing ring 40 (i.e., a diameter of the inner peripheral surface 46) in the installed state (shown in FIGS. 4A-4C, 6A and 6B) is larger than an outer diameter D_{V} of the bottom surface 52 of the circumferential groove 42 of the valve disc member 18 (shown in FIG. 3C). Thus, the resilient stainless steel sealing ring 40 is disposed in the annular groove 42 with the clearance K for radial displacement of the sealing ring 40 relative to the annular groove 42. As best shown in FIG. 6B, the inner peripheral surface 46 of the sealing ring 40 faces and is radially spaced from the bottom surface 52 of the groove 42 so that no other component of the exhaust brake valve 15 is disposed between the bottom surface 52 of the groove 42 and the inner peripheral surface 46 of the sealing ring 40. In other words, the clearance K is defined as an unoccupied annular space between the bottom surface 52 of the circumferential groove 42 of the valve disc member 18 and the cylindrical inner peripheral surface 46 of the sealing ring 40. Evidently, an outer diameter D_{RI} of the sealing ring 40 in the installed state (shown in FIG. 4B) is substantially equal to the than an interior diameter D_{C} of the exhaust gas passage 13 in the valve casing 12 (shown in FIG. 2C).

As further illustrated in FIGS. 3A-3C, the valve disc member 18 also includes a pin hole 43 provided to receive a cylindrical pin 51 (shown in FIG. 6A) arranged in a gap (slit) 50 (shown in FIG. 4B) between two opposing ends 40a and 40b of the sealing ring 40 and across the groove 42 of the valve disc member 18 to prevent rotation of the sealing ring 40 relative to the valve disc member 18.

Preferably, the exhaust brake valve with the sealing ring according to the present invention is provided to be used in a pressure relief exhaust brake system described in detail in U.S. Pat. No. 7,765,981, which is incorporated herein by reference in its entirety.

Therefore, the present invention provides a novel exhaust brake valve assembly for an exhaust brake system of an internal combustion engine. The exhaust brake valve assembly of the present invention provides low or no leakage sealing between the inner peripheral surface 14 of the valve casing 12 and the sealing ring 40 of the exhaust brake valve 15, can handle high backpressure of the exhaust gases, and resists seizing if not used regularly. Unlike the conventional exhaust brake valves, the brake valve assembly of the present invention is especially efficient at low engine speeds and provides substantial braking power at low engine speeds.

The foregoing description of the preferred embodiment of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiment disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. An exhaust gas flow control valve assembly comprising:
a valve casing made of a metallic material and forming an exhaust gas passage defining a cylindrical inner peripheral surface of said valve casing; and
a butterfly-type exhaust gas flow control valve disposed within said exhaust gas passage and movable between an open position and a closed position blocking fluid communication through said cylindrical exhaust gas passage to control the exhaust gas flow through said exhaust gas passage of said valve casing;
said exhaust gas flow control valve including:
a single-piece valve disc member having a circumferential groove formed in a circumferentially outer peripheral surface thereof; and
a flat, substantially annular resilient stainless steel sealing ring disposed in said annular groove with a clearance for radial displacement of said sealing ring relative to said annular groove;
said sealing ring including a cylindrical outer peripheral surface provided with rounded corners, said cylindrical outer peripheral surface of said sealing ring being in firm contact with said cylindrical inner peripheral surface of said valve casing solely by an elastic force of said sealing ring when said exhaust gas flow control valve is in said closed position thereof.

2. The exhaust gas flow control valve assembly as defined in claim 1, wherein said sealing ring being in the form of a flat C-ring defining a gap between two opposing ends thereof.

3. The exhaust gas flow control valve assembly as defined in claim 2, further comprising a cylindrical pin; wherein said valve disc member includes a pin hole provided to receive said cylindrical pin arranged in said gap between said two opposing ends of said sealing ring and across said groove of said valve disc member to prevent rotation of said sealing ring relative to said valve disc member.

4. The exhaust gas flow control valve assembly as defined in claim 1, wherein said exhaust gas passage has a constant circular cross-section along an entire length thereof.

5. The exhaust gas flow control valve assembly as defined in claim 1, wherein said annular groove having a cylindrical bottom surface and flat, annular opposite side surfaces.

6. The exhaust gas flow control valve assembly as defined in claim 5, wherein said sealing ring further includes a cylindrical inner peripheral surface provided with rounded corners and a pair of flat, annular opposite side surfaces substantially perpendicular to said outer and inner peripheral surfaces of said sealing ring.

7. The exhaust gas flow control valve assembly as defined in claim 6, wherein said clearance is defined as an unoccupied annular space between said bottom surface of said circumferential groove of said valve disc member and said cylindrical inner peripheral surface of said sealing ring.

8. The exhaust gas flow control valve assembly as defined in claim 1, wherein an inner diameter of said sealing ring in installed state is larger than an outer diameter of said bottom surface of said circumferential groove of said valve disc member.

9. The exhaust gas flow control valve assembly as defined in claim 1, wherein said inner peripheral surface of said valve casing 12 is nitrocarburized.

10. The exhaust gas flow control valve assembly as defined in claim 1, wherein said sealing ring is made of stainless steel heat treated to 46-54 HRC.

11. The exhaust gas flow control valve assembly as defined in claim 10, wherein said sealing ring is made of nitrocarburized stainless steel.

12. The exhaust gas flow control valve assembly as defined in claim 1, further comprising a drive shaft rotatably mounted to said valve casing so as to extend through said exhaust gas passage; wherein said butterfly-type exhaust gas flow control valve is mounted to said drive shaft within said cylindrical exhaust gas passage so as to be movable between the open position and the closed position thereof due to rotation of said drive shaft relative to said valve casing.

13. The exhaust gas flow control valve assembly as defined in claim 12, wherein said valve disc member includes a plurality of fastening holes provided to receive fasteners fastening said valve disc member to said drive shaft; all of said fastening holes disposed along a first center axis of said valve disc member such that one of said mounting holes is disposed at the intersection of said first center axis and a second center axis of said valve disc member perpendicular to said first center axis thereof.

14. The exhaust gas flow control valve assembly as defined in claim 14, further comprising a valve actuator provided for selectively controlling said exhaust brake valve; said valve actuator is non-rotatably attached to said drive shaft of said exhaust brake valve.
